(19) United States
(12) Patent Application Publication
(10) Pub. No.: US 2026/0252909 A1
(43) Pub. Date: Aug. 27, 2026

(54) ARTIFICIAL INTELLIGENCE AGENT FOR GAP ANAYLYSIS AND SOLUTION RECOMMENDATION

(71) Applicant: BOOMI, LP, Conshohocken, PA (US)

(72) Inventors: Mandip KAUR, Hicksville, NY (US); Patricia MOORE, Richmond, VA (US)

(73) Assignee: BOOMI, LP, Conshohocken, PA (US)

(21) Appl. No.: 19/060,049

(22) Filed: Feb. 21, 2025

(51) Int. Cl. G06N 5/022

(52) U.S. Cl. CPC G06N 5/022

(57) ABSTRACT

Currently, partners of an integration platform as a service (iPaaS) platform must manually identify what solutions to build for the iPaaS platform. In an embodiment, a conversational artificial intelligence (AI) agent is used to perform an opportunity analysis that is capable of reducing the creative time, required for coming up with new solutions, from months to minutes. The opportunity analysis may acquire internal and/or external data, augment and/or clean that data, and apply a predictive model to the acquired data to predict software entities that would be beneficial to a computing environment. Clustering may be performed to identify software entities that are relevant to the partner, and those solutions may be filtered to a set of recommended non-existent software entities. These recommendations may be presented to the partner within the context of a real-time chat session with the AI agent.

### BACKGROUND

### Field of the Invention

The embodiments described herein are generally directed to artificial intelligence (AI), and, more particularly, to an AI agent for gap analysis and solution recommendation.

### Description of the Related Art

Integration Platform as a Service (iPaaS) enables the integration of applications and data. The iPaaS platform provided by Boomi® of Conshohocken, Pennsylvania, provides an environment in which partners can develop and offer solutions to other organizations that manage and/or host their integration platforms on the iPaaS platform. Examples of such solutions include, without limitation, artificial intelligence (AI) agents, integration processes, connectors (e.g., which may be used by AI agents and/or integration processes), tools (e.g., to be used by AI agents), and the like. Currently, partners must manually identify and select the next solution to build based on domain expertise and guesswork.

### SUMMARY

Accordingly, systems, methods, and non-transitory computer-readable media are disclosed for an artificial intelligence (AI) agent that is configured to identify gaps in integration offerings and recommend solutions to fill those gaps.

In an embodiment, a method comprises using at least one hardware processor to, by an artificial intelligence (AI) agent, during a real-time chat session between a user and the AI agent within a chat frame of a graphical user interface: perform an opportunity analysis by acquiring data comprising internal data from an integration platform as a service (iPaaS) platform, and external data that are external from the iPaaS platform, wherein the internal data comprise a plurality of datasets that each represents an existent software entity that already exists on the iPaaS platform, applying a predictive model to the acquired data to predict a plurality of software entities that are likely to be used on the iPaaS platform, clustering the predicted plurality of software entities into one or more clusters within a vector space, wherein each of the predicted plurality of software entities is represented as a feature vector within the vector space, identifying at least one of the one or more clusters that is relevant to the user, and identifying one or more non-existent software entities from the at least one cluster, wherein each of the one or more non-existent software entities does not already exist on the iPaaS platform; and display a visual representation of each of the one or more non-existent software entities in the chat frame.

The opportunity analysis may be performed in response to an initial input within the chat frame. The initial input may be predefined.

The visual representation may comprise a natural-language expression. The method may further comprise using the at least one hardware processor to generate the natural-language expression by: generating a prompt based on the one or more non-existent software entities; and inputting the prompt to a generative language model to produce the natural-language expression.

The visual representation may comprise, for each of the one or more non-existent software entities, an input for selecting the non-existent software entity, and wherein selection of the input for each of the one or more non-existent software entities redirects the graphical user interface to a screen for building the non-existent software entity, wherein the screen comprises pre-populated data for the non-existent software entity. The visual representation may comprise, for each of the one or more non-existent software entities, an estimated revenue to be generated by the non-existent software entity. The visual representation may comprise, for each of the one or more non-existent software entities, an estimated time duration to build the non-existent software entity.

The opportunity analysis may further comprise applying an explanation model to the feature vectors to generate an explanation for each of the one or more non-existent software entities. The visual representation may comprise, for each of the one or more non-existent software entities, a natural-language expression of the explanation for that non-existent software entity.

The opportunity analysis may further comprise: matching at least one of the predicted plurality of software entities to at least one of the existent software entities; and based on the match, excluding the at least one predicted plurality of software entities from the one or more non-existent software entities.

The opportunity analysis may further comprise: matching at least one of the predicted plurality of software entities to at least one software entity that is being built by another user; and based on the match, excluding the at least one predicted plurality of software entities from the one or more non-existent software entities.

At least one of the existent or non-existent software entities may be an integration process. At least one of the existent or non-existent software entities may be an AI agent. At least one of the existent or non-existent software entities may be a connector to a third-party application.

The internal data may further comprise search queries within a marketplace of the iPaaS platform. The internal data may further comprise usage statistics for the existent software entities. The external data may comprise one or more online articles.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example of a process for gap analysis and solution recommendation, according to an embodiment; and

FIGS. 4A-4F illustrate an example of a graphical user interface for gap analysis and solution recommendation, according to an embodiment.

### DETAILED DESCRIPTION

In an embodiment, systems, methods, and non-transitory computer-readable media are disclosed for an artificial intelligence (AI) agent that is configured to identify gaps in integration offerings and recommend solutions for those gaps. In other words, the AI agent provides opportunities to a user. In an embodiment, the AI agent may autonomously analyze usage data, along with external factors (e.g., trends, economics, regulations, etc.), to provide recommendations to partners about what solutions to build. These recommendations may also estimate how long each solution will take to build, forecast sales revenue or market size for each solution, and/or the like, to empower the partners to make informed decisions on where to spend their development time and align their efforts with market demand and trends. Utilization of the AI agent can reduce the uncertainty and risk associated with development and enable partners to focus on projects with the highest potential for success, while increasing the number of beneficial solutions on the market and revenue for the partners, as well as for the organizations that use their solutions.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Infrastructure

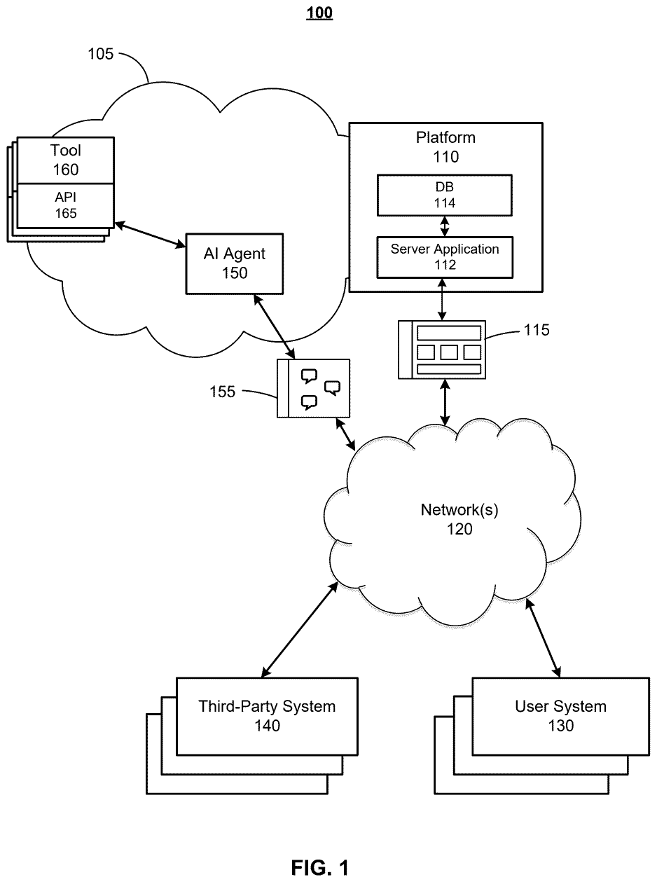

FIG. 1 illustrates an example infrastructure 100, in which one or more of the processes described herein may be implemented, according to an embodiment. Infrastructure 100 may comprise a computing environment 105 which hosts and/or executes one or more of the disclosed processes, which may be implemented in software and/or hardware. Computing environment 105 may be a cloud-computing environment, which is a server environment in which computing services are dynamically and elastically allocated to one or more tenants (e.g., organizations, including partners, customers, etc.) based on demand. This cloud-computing environment may be a public cloud (e.g., owned and operated by a different party than the tenant(s)), a private cloud (e.g., dedicated to a single tenant), or a hybrid cloud (e.g., comprising a combination of public and private cloud elements). In any case, the servers may be collocated and/or geographically distributed within one or more data centers.

Computing environment 105 may comprise and/or be managed by a platform 110. Platform 110 may comprise a server application 112 and/or a database 114. Server application 112 may manage computing environment 105. In particular, server application 112 may provide a user interface 115 and backend functionality, including one or more of the processes disclosed herein, to enable users, via user systems 130, to construct, develop, modify, save, delete, test, deploy, un-deploy, and/or otherwise manage software entities within computing environment 105. User interface 115 may comprise a graphical user interface that implements a low-code environment, including potentially a no-code environment, in which users may construct software entities.

In an embodiment, platform 110 implements integration platform as a service (iPaaS) within computing environment 105. In this case, computing environment 105 may comprise a plurality of integration platforms (not shown). Each integration platform may comprise one or more, and generally a plurality of, integration processes (not shown). Each integration platform may be associated with an organization, which may be associated with one or more user accounts by which respective user(s) manage the organization's integration platform, including the various integration process(es).

An integration process may represent a transaction involving the integration of data between two or more systems, and may comprise a series of elements that specify logic and transformation requirements for the data to be integrated. Each element, which may also be referred to as a “step” and have a visual representation referred to as a “shape,” may transform, route, and/or otherwise manipulate data to attain an end result from input data. For example, a basic integration process may receive data from one or more data sources (e.g., via an application programming interface (API) of the integration process), manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process may represent a business workflow or a portion of a business workflow or a transaction-level interface between two systems, and comprise, as one or more steps, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software.

The functionality of server application 112 may include a process for constructing an integration process within one or more screens of a graphical user interface of user interface 115. Embodiments of such functionality are disclosed, for example, in U.S. Pat. No. 8,533,661,issued on Sep. 10, 2013, and U.S. Pat. No. 11,886,965, issued on Jan. 30, 2024, which are both hereby incorporated herein by reference as if set forth in full. In particular, these applications describe functionality that enable the construction of integration processes on a virtual canvas.

Computing environment 105 and/or platform 110 may be communicatively connected to one or more networks 120. Network(s) 120 enable communication between computing environment 105, platform 110, user system(s) 130, and/or third-party system(s) 140. Network(s) 120 may comprise the Internet, and communication through network(s) 120 may utilize standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While the various systems are illustrated as being connected to each other through a single set of network(s) 120, it should be understood that the systems could be connected via different sets of one or more networks. For example, platform 110 may be connected to a subset of user systems 130 and/or third-party systems 140 via the Internet, but may be connected to another subset of user systems 130 and/or third-party systems 140 via an intranet.

While only a few user systems 130 are illustrated, it should be understood that computing environment 105 and/or platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal or professional workstation of a developer of software entities, such as artificial intelligence (AI) agents, tools, integration processes, and/or the like, to be used within computing environment 105. As one example, the developer may be an integration developer that constructs and manages integration processes for an organization. When platform 110 is an iPaaS platform, each integration developer may have a user account that is associated with an overarching organizational account for managing an integration platform on the iPaaS platform.

As another example that is of particular relevance to disclosed embodiments, the developer may be a partner of platform 110 (e.g., an iPaaS platform) who develops software entities for platform 110. For instance, platform 110 may provide or be communicatively coupled to a marketplace through which users of platform 110 may sell, purchase, or otherwise exchange software entities to be used within computing environment 105. In this case, platform 110 may provide a partner portal through which partners can construct new software entities, modify existing software entities, register software entities within a registry of software entities available through the marketplace, offer software entities for sale, market software entities, and/or otherwise manage software entities. Other users may purchase and/or otherwise acquire a software entity, offered by a partner, and deploy that software entity (e.g., AI agent, tool, integration process, etc.) within computing environment 105 (e.g., to an integration platform within computing environment 105), connect to that software entity from within computing environment 105 (e.g., via an application programming interface of the software entity), integrate that software entity into another software entity (e.g., integration process), and/or the like.

The user of a user system 130 may authenticate with platform 110 using standard authentication means, to access server application 112 in accordance with permissions or roles of the associated user account. The user may then interact with server application 112 to manage one or more software entities within computing environment 105, for example, within an integration platform within computing environment 105. It should be understood that multiple users, on multiple user systems 130, may manage the same software entities and/or different software entities in this manner, according to the permissions or roles of their associated user accounts.

One or more third-party systems 140 may be communicatively connected to network(s) 120, such that each third-party system 140 may communicate with a software entity (e.g., AI agent, tool, integration process, etc.), deployed within computing environment 105, via an application programming interface. Third-party system 140 may host and/or execute a software application that pushes data to the software entity, and/or pulls data from the software entity via an application programming interface. Additionally or alternatively, a software entity may push data to a software application on third-party system 140, and/or pull data from a software application on third-party system 140 via an application programming interface of third-party system 140. Thus, third-party system 140 may be a client or consumer of one or more software entities, a data source for one or more software entities, and/or the like. As examples, the software application on third-party system 140 may comprise, without limitation, enterprise resource planning (ERP) software, customer relationship management (CRM) software, accounting software, and/or the like.

A software entity, once deployed, may be communicatively coupled to network(s) 120. For example, the software entity may comprise an application programming interface that enables another software entity (e.g., across network(s) 120 and/or within computing environment 105) to access one or more operations available via the software entity. Alternatively or additionally, the software entity may access one or more operations of another software entity via an application programming interface of that other software entity.

Of particular relevance to disclosed embodiments, one of the software entities, within computing environment 105 and/or otherwise available via platform 110, may be an AI agent 150 that is configured to perform an opportunity analysis that includes performing gap analysis and recommending solutions to fill those gaps. It is generally contemplated that AI agent 150 would be used by partners of platform 110 to identify new software entities to be developed, as solutions to identified gaps in computing environment 105. In this case, AI agent 150 may be accessed through a partner portal of user interface 115. However, in an alternative or additional embodiment, AI agent 150 could be used by integration developers of organizations to develop new software entities to be used on their respective organization's integration platform within computing environment 105. In this case, AI agent 150 may be accessed through a customer portal of user interface 115.

AI agent 150 may communicate via a user interface 155. User interface 155 may be comprised within user interface 115 of platform 110, or may be separate and distinct from user interface 115. It is contemplated that AI agent 150 would implement a real-time chat session within a chat frame of user interface 155. This chat frame may be overlaid on or otherwise visually integrated into a graphical user interface of user interface 115. Alternatively or additionally, the real-time chat session could be implemented within an audio interface of user interface 155. In this case, a user's speech may be converted into text (e.g., via a speech-to-text engine) and/or text generated by AI agent 150 may be converted into speech (e.g., via a text-to-speech engine), within the audio interface. In yet another alternative, the real-time chat session could be implemented within an audiovisual interface of user interface 155, which combines a graphical user interface with an audio interface. In any case, a user may interface with AI agent 150 using natural language. As used herein, the term “natural language” or “natural-language” refers to language, including grammar, that would be expected in a normal conversation between two humans.

AI agent 150 may utilize one or more tools 160 to perform the opportunity analysis, including the tasks of gap analysis and solution recommendation. A tool 160 may be hosted within computing environment 150, on platform 110, on a third-party system 140, or anywhere else, as long as AI agent 150 is communicatively coupled to tool 160 (e.g., via network(s) 120). Each tool 160 may implement an application programming interface 165 that provides access to one or more operations by AI agent 150. AI agent 150 may perform a remote procedure call to a function of the application programming interface 165 that implements an operation, potentially with one or more parameters as inputs to the function, in order to initiate an operation by tool 160. Tool 160 may perform the operation and return a result, which may be used by AI agent 150 to formulate responses to inputs by the user within the real-time chat session. Examples of operations include, without limitation, retrieving internal data, retrieving external data, cleaning data, filtering data, augmenting data, generating a data object, updating data, and/or the like.

AI agent 150 may comprise or be communicatively coupled to one or more models. AI agent 150 may utilize the model(s) to formulate responses to inputs by the user within the real-time chat session. For example, a model may be used to perform gap analysis, extract features from data, cluster data, explain a result of another model, generate recommendations, summarize data, interpret data, analyze data, determine what data to collect, and/or the like. A model may be a machine-learning model, a mathematical model, a statistical model, a rules-based model, a symbolic AI model, a heuristic model, a simulation model, or any other suitable type of model. Examples of specific types of models include, without limitation, an artificial neural network (e.g., a deep-learning neural network (DNN), recurrent neural network (RNN), graph neural network (GNN), or the like), a random forest algorithm, a linear regression algorithm, a logistic regression algorithm, a decision tree, a support vector machine (SVM), a naïve Bayes algorithm, a k-Nearest Neighbors (kNN) algorithm, a K-means algorithm, a dimensionality reduction algorithm, a gradient-boosting algorithm, a Markov chain, a compact prediction tree (CPT), and/or the like.

In an embodiment, at least one model, used by AI agent 150, may be a generative model, such as a generative language model. For instance, AI agent 150 may utilize the generative language model to generate natural-language expressions. AI agent 150 may generate a prompt using collected data, for example, by inserting the data into a predefined template. The predefined template may comprise a pre-conversation and/or post-conversation, which provide context and/or instructions for the generative language model, and a placeholder into which the data are inserted. The pre-conversation and/or post-conversation may define the role of the generative language model (e.g., to summarize the data, analyze the data, interpret the data, augment the data, decide what to do with the data, etc.), define an output format for the generative language model (e.g., a list structure, a hierarchical structure, a markup-language structure, a combination of structures, etc.), and/or the like. AI Agent 150 may input the generated prompt to the generative language model to produce an output, which may comprise a natural-language expression, a data structure, and/or the like.

The generative language model may comprise or consist of a large language model. One well-known example of a large language model is the Generative Pre-trained Transformer (GPT). GPT-4 is the fourth-generation language prediction model in the GPT-n series, created by OpenAI™ of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models, such as any of the Claude family of large language models (e.g., Claude 3 Opus) developed by Anthropic PBC of San Francisco, California, the Falcon large language model (e.g., Falcon 180B) released by the United Arab Emirates'Technology Innovation Institute (TII), the Large Language Model Meta AI (LLaMA) model (e.g., LLaMA 2) released by Meta AI of New York, New York, the Gemini model by Google LLC of Mountain View, California, the Mistral family of models released by Mistral AI of Paris, France, and the like. Alternatively or additionally, the generative language model may comprise or consist of a code-completion model that is trained to produce source code, data structures represented in a markup language (e.g., XML, HTML, etc.) or other format, and/or the like. A pre-trained generative language model may used as a base model that is fine-tuned for the specific task of gap analysis and/or solution recommendation.

It should be understood that, for any given input by the user within the real-time chat session, AI agent 150 may use zero, one, or more models and/or zero, one, or more tools 160. Depending on the given input, AI agent 150 may need to utilize only a single model, only a plurality of models, only a single tool, only a plurality of tools, a combination of one model and one tool, a combination of a plurality of models and one tool, a combination of a plurality of models and a plurality of tools, or no model and no tool. As a basic example, AI agent 150 may need to collect data from the user, in which case, AI agent 150 may use a generative language model to ask a series of questions. As another example, AI agent 150 may need to collect data from an external source, in which case, AI agent 150 may use a tool 160 to collect data (e.g., from a third-party system 140). As yet another example, AI agent 150 may need to analyze data, in which case, AI agent 150 may use a first model to analyze the data, a second model to interpret or explain the result of the analysis, and a generative language model to summarize the explanation of the result of the analysis. As an even further example, AI agent 150 may need to utilize a particular operation of a tool 160, in which case, AI agent 150 may use a generative language model to collect necessary inputs to the operation, call a function of application programming interface 165 of tool 160, using the collected inputs, to perform the operation, and then use a generative language model to summarize, explain, or otherwise convey the result of the operation. It should be understood that these are just a few non-limiting examples, and that there are a virtually infinite number of other possibilities of how AI agent 150 may utilize model(s) and/or tool(s) 160.

It should be understood that, even though AI agent 150 is described as performing the disclosed opportunity analysis, this general description of AI agent 150 may apply to any other AI agent in computing cloud 105 or elsewhere. In particular, any AI agent may utilize one or more models and/or one or more tools 160, in any combination and/or sequence, to perform the task(s) assigned to that AI agent. In some cases, such AI agents may be the solutions (i.e., software entities) that are being recommended by AI agent 150.

### 2. Example Processing System

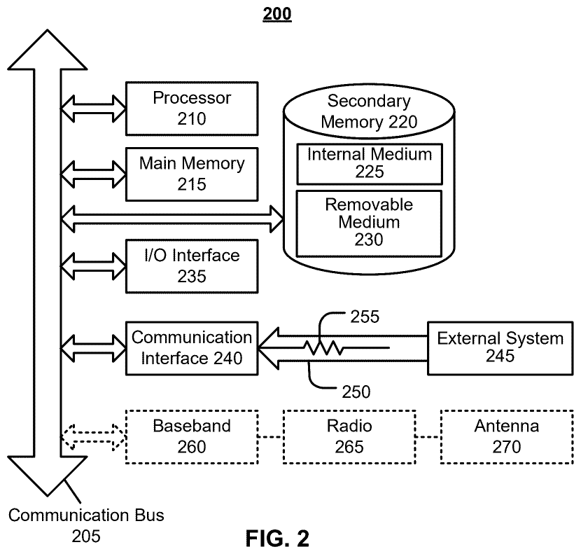

FIG. 2 illustrates an example processing system, by which one or more of the processes described herein may be executed, according to an embodiment. For example, system 200 may be used to store and/or execute server application 112, and/or may represent components of computing cloud 105, platform 110, user system(s) 130, third-party system 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Process

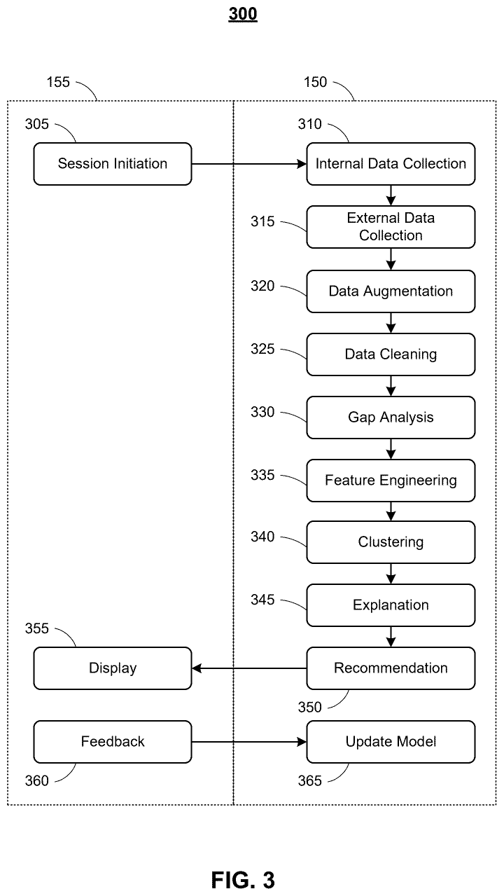

FIG. 3 illustrates an example of a process 300 for gap analysis and solution recommendation, according to an embodiment. In process 300, the front end of AI agent 150 (i.e., user interface 155) may implement modules 305, 355, and/or 360, and the back end of AI agent 150 may implement modules 310, 315, 320, 325, 330, 335, 340, 345, 350, and/or 365. All of the modules are preferably implemented as software modules, but could also be implemented as hardware modules or as modules comprising a combination of hardware and software.

While process 300 is illustrated with a certain arrangement and ordering of subprocesses, process 300 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Initially, module 305 may initiate a session between a user and AI agent 150. In particular, a user may interact with server application 112 (e.g., by selecting an input within a graphical user interface of user interface 115) to open the graphical user interface of user interface 155 of AI agent 150. For example, the graphical user interface of AI agent 150 may slide out or pop up as a frame over the graphical user interface of server application 112. This frame may be a chat frame through which the user can converse with AI agent 150 in a real-time chat session. In an embodiment, the initiation of the session may automatically submit a predefined input to AI agent 150, on behalf of the user. The predefined input (e.g., “Analyze my opportunities on the platform”) may request AI agent 150 to provide opportunities (i.e., identify gaps and recommend solutions) for the user. Essentially, module 305 seeds the real-time chat session with an initial task-specific request to AI agent 150. Alternatively, module 305 may initiate the session by prompting the user, for example, for information to focus the opportunity analysis (e.g., a particular industry, field, type of user, revenue expectation, development time duration, etc.).

In fulfilling its task, AI agent 150 may execute modules 310-350. Collectively, modules 310-350 represent the opportunity analysis of disclosed embodiments. This opportunity analysis may be performed by AI agent 150 during a real-time chat session between a user and AI agent 150, for example, within a chat frame of a graphical user interface of user interface 155. As discussed above, this opportunity analysis may be performed in response to an initial input (e.g., predefined input) within a chat frame.

Initially, modules 310 and 315 may acquire data to be used by one or more subsequent modules. In particular, module 310 may collect internal data from internal data sources within computing environment 105 and/or platform 110, which may be an iPaaS platform, whereas module 315 may collect external data from external data sources (e.g., third-party system(s) 140) that are external to computing environment 105 and/or platform 110. It should be understood that the internal data may be collected from hundreds, thousands, millions, billions, trillions, or more of instances of integration platforms, integration processes, deployments, installations, executions, marketplace purchase, user accounts, and/or the like. Similarly, the external data may be collected from hundreds, thousands, millions, billions, trillions, or more of online resources, including websites, webpages, electronic documents, and/or the like.

The internal data may comprise firmographic information (e.g., industry, target market, business model, etc.) for the user's (e.g., partner's) specific organization, firmographic information for other organizations operating within computing environment 105, common integration processes that are used across a plurality of organizations operating within computing environment 105 (e.g., operating integration platforms on an iPaaS platform), usage data for software entities (e.g., connectors) operating within computing environment 105, product information (e.g., description, popularity, revenue, etc.) for software entities currently being offered within a marketplace of platform 110, project information for software entities that other users (e.g., partners) are in the process of building or have already built (e.g., derived from opportunity analyses performed by AI agent 150 for the other users), search results performed by other users (e.g., customers) within the marketplace of platform 110, installation statistics for software entities available through platform 110, revenue information for software entities operating within computing environment 105, and/or the like. In an embodiment, the internal data at least comprise a plurality of datasets that each represents an existent software entity that exists on platform 110, search queries within the marketplace of platform 110, and/or usage statistics for the existent software entities. The existent software entities may comprise integration processes, AI agents, connectors to third-party applications, and/or the like.

The external data may comprise industry trends, regulations, including changes in regulations, news articles, blogs, and/or the like. In an embodiment, the external data at least comprise one or more online articles. These online article(s) may describe industry trends, changes in regulations, news, opinions, and/or the like.

Module 320 may augment the internal data, collected by module 310, and/or the external data, collected by module 315. For example, module 320 may prioritize (e.g., weight) data elements in the collected data, relative to each other. The prioritized data may represent upcoming, near-term, and/or urgent customer requirements. Module 320 may rely on external data sources (e.g., external data collected by module 315) that are related to the user (e.g., partner) for which the opportunity analysis is being performed. The external data may comprise trends, changes in regulations, and/or other information that would impact the value and/or urgency of data elements, relative to each other, within the collected data. As an alternative or in addition to prioritizing data elements in the collected data, module 320 may perform other types of augmentation, such as forming connections between related data elements, reorganizing data elements, computing new data elements from the collected data elements, and/or the like.

Module 325 may clean the internal data, collected by module 310, and/or the external data, collected by module 315, and potentially augmented by module 320, to standardize or normalize the data elements, remove noise, filter out or fix data elements with missing values, and/or otherwise improve the quality of the collected data. Although illustrated as being performed after the data augmentation of module 320, module 325 could alternatively be performed before the data augmentation of module 320. In this case, the data augmentation may be performed on the cleaned data, as opposed to the raw data, that were collected by modules 310 and/or 315.

Module 330 may perform gap analysis. Gap analysis analyzes the data collected by modules 310 and/or 315, and potentially augmented by module 320 and/or cleaned by module 325, to identify one or more gaps in the collected data, which may represent gaps in the set of software entities that are available via platform 110. As used herein, the term “gap” may refer to any need or desire within computing environment 105 that may be solved by a software entity. For example, a gap may be the lack of a function that would enable a software entity to operate more efficiently and/or effectively, the lack of a connector that would enable two software entities to communicate or to communicate more efficiently or effectively, the lack of a software entity to perform a function of which numerous users have need (e.g., for which numerous users have searched the marketplace of platform 110) or which would otherwise be useful to users, or the like. In an embodiment, the gap analysis essentially determines products that are missing from those products that are currently offered in the marketplace of platform 110 and/or operating in computing environment 105.

Module 330 may utilize predictive analytics to perform the gap analysis. Predictive analytics utilizes historical data (i.e., the internal data collected by module 310 and/or the external data collected by module 315) to form predictions about unknown data, such as future events. In this case, the predictive analytics is forming predictions about which software entities would be useful (e.g., likely to be purchased, deployed, or otherwise used, successful in the marketplace, needed, in high demand, etc.) based on the historical data.

The predictive analytics may be implemented by a predictive model of AI agent 150. In other words, module 330 may apply a predictive model to the acquired data (e.g., collected by modules 310 and/or 315) to predict a plurality of software entities that are likely to be used on platform 110. This predictive model may exploit patterns in the acquired data to identify opportunities for new software entities. These patterns may be learned using customer segmentation (e.g., representing demographic and/or behavioral data for users of computing environment 105), comparisons between internal metrics and/or trends against external benchmarking and/or trends, clustering of users into groups based on behavior, feedback, usage, and/or the like (e.g., using k-means clustering, x-prototype clustering, density-based spatial clustering of applications with noise (DBSCAN), hierarchical clustering, etc.), and/or the like. The predictive model may identify gaps in the patterns, representing missing capabilities, missing data, underperforming areas, and/or the like. This provides actionable insights so that these gaps can be bridged for optimal outcomes. The predictive model may comprise a machine-learning model (e.g., a deep-learning neural network or other artificial neural network), a regression analysis, and/or any other suitable model.

In the event that the predictive model is a machine-learning model, the predictive model may be trained via unsupervised or supervised learning. In the case of supervised learning, the predictive model may be trained using historical data that are crowd-sourced from all users within computing environment 105. For example, historical internal and external data may be collected, augmented, and/or cleaned for a first past time period within the historical data, in the same manner as described above with respect to modules 310-325. A plurality of feature vectors may be extracted from this historical data, and each of the plurality of feature vectors may be labeled with a historical software entity that was built within a second past time period that temporally follows or is subsequent to the first past time period, and which was successful (e.g., achieved a predefined threshold of revenue, number of purchases within the marketplace, number of deployments, etc.). The labels may include additional information about these successful software entities, such as the amount of revenue generated by each respective software entity, the time duration required to build each respective software entity, and/or the like. Each label may comprise a target feature vector representing the respective software entity. The predictive model may then be trained by minimizing a loss function over a plurality of training iterations. In each training iteration, one feature vector from the historical data may be input to the predictive model to output a predicted software entity, the loss function may calculate an error between the predicted software entity and the historical software entity with which the feature vector is labeled, and one or more weights in the predictive model may be adjusted, according to a suitable technique (e.g., gradient descent), to reduce the error of the loss function. A training iteration may be performed for each of the labeled plurality of feature vectors. It should be understood that there may be thousands, tens of thousands, hundreds of thousands, millions, tens of millions, hundreds of millions, billions or more such labeled feature vectors within a training dataset.

The output of the predictive model may comprise one or more datasets that each represents a software entity that is predicted to be beneficial (e.g., likely to be used) given the historical data. Each dataset may comprise, without limitation, an identifier (e.g., brand name) of a software application (e.g., to which the software entity would connect), the type of the software application (e.g., identifying what the software application does), the type of the predicted software entity (e.g., AI agent, integration process, connector, tool, etc., identifying what the predicted software entity does, etc.), and/or the like. As an example, the collected data may indicate the existence of a first type of software entity (e.g., connector) and a second type of software entity (e.g., AI agent) for App X, and also that a competing App Y is trending. In this case, the predictive analytics of module 330 may predict that both the first type of software entity for App Y and the second type of software entity for App Y would be beneficial.

Module 330 may filter out existing software entities from those represented by datasets in the output of the predictive model. For example, module 330 may compare each predicted software entity, represented by a dataset in the output of the predictive model, to software entities that already exist in a marketplace of platform 110. Any predicted software entity that matches an existing software entity (e.g., in terms of the software application, type of software entity, etc.) may be excluded from the output of module 330. In other words, the opportunity analysis may comprise matching at least one of the predicted plurality of software entities to at least one existent software entity, and based on the match, excluding the at least one predicted software entity from the software entities to be recommended to the user. Additionally, module 330 may compare each of these predicted software entities to software entities that are currently under development by the user and/or other users (e.g., other partners). Any predicted software entity that matches a software entity under development (e.g., in terms of the software application, type of software entity, etc.) may also be excluded from the output of module 330. In other words, the opportunity analysis may comprise matching at least one of the predicted plurality of software entities to at least one software entity that is being built by another user, and based on the match, excluding the at least one predicted software entity from the software entities to be recommended to the user.

Module 330 may output one or more datasets that each represents a software entity that was predicted to be beneficial by the predictive model and was not filtered out (e.g., did not match an existing software entity or software entity under development). Continuing the example above, module 330 may determine that the first type of software entity for App Y already exists or is currently under development, but that the second type of software entity for App Y does not already exist and is not currently under development. In this case, the output of module 330 would include the second type of software entity for App Y, but not the first type of software entity for App Y. It should be understood that the software entities, represented in the output of module 330, represent gaps (i.e., software entities that do not currently exist, and potentially that nobody is currently building). The creation of one of the non-existent software entities by the user (e.g., partner) would represent a solution to a gap.

Module 335 may perform feature engineering on the output of module 330, representing the result of the gap analysis. The feature engineering may process the output of module 330 for use as a set of features in a clustering model of AI agent 150. In particular, module 335 may transform each dataset, representing a non-existent software entity, in the output of module 330, into a feature vector, comprising a value for each of a plurality of features. This transformation of each dataset may comprise selecting or extracting a field value in the dataset to be used as the value of a feature, computing the value of a feature from one or more field values in the dataset, and/or otherwise determining the value of a feature based on one or more field values in the dataset. Each feature vector represents a non-existent software entity, and each feature represents a dimension within a vector space. Each value of a feature within the feature vector represents a position of the non-existent software entity in the represented dimension, and the feature vector as a whole represents the position of the non-existent software entity within the vector space. The output of module 335 may be a plurality of feature vectors. Examples of features include, without limitation, type of software entity, relevant industry, relevant sector (e.g., finance, healthcare, retail, etc.), estimated revenue, estimated time duration to build, estimated usage frequency, business size, location, and/or the like. It should be understood that there may be thousands, tens of thousands, hundreds of thousands, millions, tens of millions, hundreds of millions, billions or more such feature vectors.

Each of the plurality of feature vectors, in the output of module 335, represents the position of a non-existent software entity within the same vector space. In other words, the non-existent software entities are embedded within a single vector space. This enables the similarity between any pair of software entities, embedded within the vector space, to be easily calculated according to a similarity metric. Any suitable similarity metric may be used. As an example, the similarity metric may be a distance between a pair of feature vectors who similarity to each other is being measured. This distance may be a Euclidean distance, Manhattan distance, Cosine distance, Hamming distance, Minkowski distance, Chebyshev distance, Jaccard distance, Haversine distance, Sorensen-Dice distance, or the like.

Module 340 may cluster the predicted plurality of software entities, from the gap analysis of module 330, into one or more, and generally a plurality of, clusters. Each of the predicted plurality of software entities may be represented as a feature vector within the vector space. In particular, the plurality of feature vectors, output by module 335, may be grouped into a plurality of clusters, using the similarity metric, according to any suitable clustering algorithm. In an embodiment, the clustering algorithm is the K-Means algorithm, which is described in Lloyd, S., “Least squares quantization in PCM,” IEEE Transactions on Information Theory, 28 (2):129-137,doi: 10.1109/TIT.1982.1056489, which is hereby incorporated herein by reference as if set forth in full. The K-Means algorithm groups feature vectors together based on their similarities in distance to the centroids of respective clusters, while attempting to minimize the sum of squared distances between each feature vector and the centroid of its assigned cluster. In a preferred embodiment, the clustering algorithm is the K-Prototype algorithm. The K-Prototype algorithm is an extension of the K-Means algorithm that is specifically designed to cluster mixed data types, including integers, real numbers, categories, strings, and/or the like. Thus, the K-Prototype algorithm is well suited to cluster feature vectors that comprise both numerical features and categorical features. The K-Prototype algorithm was introduced in Huang, Z., “Clustering large data sets with mixed numeric and categorical values,” Proceedings of the First Pacific Asia Knowledge Discovery and Data Mining Conference, Singapore, pp. 21-34, 1997, which is hereby incorporated herein by reference as if set forth in full. Examples of other suitable clustering algorithms include, without limitation, the K-Modes algorithm (e.g., suitable for feature vectors that consist of only categorical features), the Density-Based Spatial Clustering of Applications with Noise (DBSCAN) algorithm, the Gaussian Mixture Model (GMM) algorithm, the Balanced Iterative Reducing and Clustering using Hierarchies (BIRCH) algorithm, the Affinity Propagation clustering algorithm, the Mean-Shift clustering algorithm, the Ordering Points to Identify the Clustering Structure (OPTICS) algorithm, the Agglomerative Hierarchy clustering algorithm, and the like, including variations and extensions of any of these algorithms.

Module 340 may also identify one or more clusters that are relevant to the user. Relevant clusters may be identified by matching the value of each of one or more features in a cluster to the value of that feature for the user, according to the similarity metric. A matching value may be one for which the similarity metric satisfies a threshold (e.g., for which the similarity metric is below a threshold in an embodiment in which the similarity metric represents a distance). The values of the features for a user may be stored in a user profile. Alternatively, a feature vector could be derived from each of one or more, and potentially all, of the software entities of the user (e.g., software entities which have been previously built by the user), in the same manner as they were derived for the non-existent software entities in module 335. In this case, any cluster that matches the feature vector of the user's existent software entity, according to the similarity metric (e.g., for which the similarity metric satisfies a threshold), may be identified as relevant to the user.

The output of module 340 may be one or more datasets that each represents a non-existent software entity within a cluster that has been identified as relevant to the user. The output may comprise or consist of every non-existent software entity in every relevant cluster. Alternatively, the output may comprise or consist of every non-existent software entity in only the most relevant cluster. As another alternative, the output may comprise or consist of only a subset (e.g., sampling) of the non-existent software entities (e.g., closest to the software entity(ies) of the user according to the similarity metric) in every relevant cluster or only the most relevant cluster. In any case, the output may comprise a single non-existent software entity or a plurality of non-existent software entities. In the event that a plurality of non-existent software entities are identified in relevant cluster(s), the number of non-existent software entities within the output may be constrained to a certain number or percentage of all of the identified non-existent software entities. For example, the output may be limited to only a top number (e.g., top three, top five, top ten, etc.) of the most relevant non-existent software entities, with relevance determined according to the similarity metric (i.e., with a first non-existent software entity with a value of the similarity metric that indicates more similarity than a second non-existent software entity being ranked higher than the second non-existent software entity). This can prevent the user from being overwhelmed with too many recommendations. It should be understood that each of the non-existent software entities does not already exist on platform 110, which may be an iPaaS platform.

In an embodiment, module 345 applies an explanation model to produce an explanation for each of the non-existent software entities in the output of module 340. For example, the explanation model may be applied to the feature vectors, used by module 330 and/or 340, to generate an explanation for each non-existent software entity that is output by module 330 and/or 340. Each explanation can be used to explain why one of the non-existent software entities in the output was output by module 330 and/or module 340. In particular, the explanation may indicate the contribution (e.g., percentage contribution) of each of the plurality of features to the output of the respective module. The subset of one or more features, from among the plurality of features, that contributed the most to the output, essentially explains why the associated non-existent software entity was output. For example, in the case of module 340, if a non-existent software entity was identified as relevant, the subset of feature values for the non-existent software entity, within the vector space, that were relatively closest to the corresponding feature values of the user, according to the similarity metric, can be inferred to be the reason why the non-existent software entity was identified as relevant.

In an embodiment, the explanation model of module 345 comprises or consists of the Local Interpretable Model-agnostic Explanations (LIME) model, which is described in Ribeiro, M. et al., “Model-Agnostic Interpretability of Machine Learning,” arXiv: 1606.05386v1, 2016, which is hereby incorporated herein by reference as if set forth in full. The LIME model may produce explanations based on inputs to a model and their corresponding outputs from the model. In particular, the LIME model perturbs each input feature vector by changing the value of one or more features to produce a plurality of perturbed feature vectors, inputs each of a plurality of perturbed feature vectors into the model, and observes the changes in the output of model with each perturbation. From these observations, the LIME model is able to approximate the model with an interpretable model (e.g., linear model), to produce an explanation of how the original input feature vector produced the output of the model. In producing the explanation, the LIME model may weight each perturbed input feature vector according to its similarity to the original input feature vector. The explanation, output by the LIME model, may be a contribution value for each of the plurality of features, such as the percentage that each feature contributed to the output of the model. Another suitable example of the explanation model is the Shapley Additive Explanations (SHAP) model, which is described in Lundberg, S. et al., “A unified approach to interpreting model predictions,” Advances in Neural Information Processing Systems, 2017, which is hereby incorporated herein by reference as if set forth in full. Both the LIME model and the SHAP model are model-agnostic, such that they can be trained regardless of the particular model that is used. In an alternative embodiment that does not provide explanations, module 345 may be omitted. It should be understood that the model, being explained, may be the model of module 330 (e.g., explaining why the non-existent software entity is being recommended) and/or module 340 (e.g., explaining why the non-existent software entity is relevant to the user).

Module 350 may generate a visual representation of the non-existent software entity(ies), output by module 340, along with the explanation(s) for why those non-existent software entity(ies) are being recommended, as output by module 345. As described elsewhere herein, the visual representation may comprise an introduction to the recommendation, a tile that describes each recommended non-existent software entity, a summary of each recommended non-existent software entity, an input to initiate a new project for building any one of the recommended non-existent software entities, and/or the like. The summary of each recommended non-existent software entity may include a brief description of the software entity, the estimated time duration to build the software entity, the estimated or potential revenue that may be generated by the software entity, and/or the like, to enable the user to determine whether or not to invest time and resources into building and publishing the software entity (e.g., on platform 110).

The visual representation may comprise a natural-language expression that links all of the components of the recommendation together. For instance, in an embodiment, the natural-language expression is automatically generated using a generative language model of AI agent 150. In particular, module 350 may generate a prompt based on the one or more non-existent software entities, output by module 340, and/or the explanation(s) output by module 345, and inputting that prompt to a generative language model of AI agent 150 to produce the natural-language expression. The prompt may be generated by inserting each recommended non-existent software entity and/or the explanation for that recommendation, which may comprise a list of contribution values for each of the plurality of features or a subset of the plurality of features having the highest contribution values, into a predefined template. The predefined template may comprise a pre-conversation and/or post-conversation, which provide context and/or instructions for the generative language model, and a placeholder into which the recommended non-existent software entity(ies) and/or the corresponding explanation(s) are inserted. The pre-conversation and/or post-conversation may define the role of the generative language model (e.g., to summarize the recommendations), define an output format for the generative language model (e.g., a sectional structure, a list structure, a hierarchical structure, a markup-language structure, etc.), and/or the like.

Module 355 may display the visual representation of each of the non-existent software entity(ies) in the recommendation, generated by module 350, within the graphical user interface of user interface 155. For example, the visual representation may be displayed as a response in the chat frame through which the real-time chat session was initiated. It should be understood that, from the user's perspective, the user is simply chatting with AI agent 150 as a chatbot, just as the user would chat with a human.

The visual representation may comprise information about each of the non-existent software entity(ies) that are being recommended. For example, the visual representation may comprise, for each of the non-existent software entity(ies), a name of the non-existent software entity, a brief description of the non-existent software entity, an estimated revenue to be generated by the non-existent software entity, an estimated time duration to build the non-existent software entity, and/or the like. The brief description of the non-existent software entity may comprise or consist of a natural-language expression of an explanation (e.g., generated by module 345) of why the non-existent software entity is being recommended.

In an embodiment, the visual representation comprises, for each of the non-existent software entity(ies) that are being recommended, an input for selecting that non-existent software entity. Each input may initiate a new project for building the respective recommended non-existent software entity. For instance, in response to the selection of one of these input(s) by a user, the graphical user interface may be redirected to a screen for building the non-existent software entity. This screen may comprise pre-populated data for the non-existent software entity. In particular, one or more field values of the project may be pre-populated, one or more components of the new software entity may be pre-generated or pre-built, and/or the like. As an example, if the software entity is an integration process, the screen may comprise a virtual canvas on which shapes, representing pre-generated or pre-built components of the integration process, are arranged according to a recommended or standard design. The shapes may be configured to be dragged and dropped, so as to enable rearrangement of the components of the integration process on the virtual canvas, and selectable, so as to enable configuration of each component.

The visual representation may comprise or be associated with one or more inputs for providing feedback about the set of recommended non-existent software entity(ies). For example, the inputs may comprise a positive input (e.g., thumbs-up icon) and a negative input (e.g., thumbs-down icon). Module 360 may receive feedback via the inputs. In particular, module 360 receives positive feedback when the positive input is selected by the user, and receives negative feedback when the negative input is selected by the user.

In an embodiment, after a first set of recommended non-existent software-entity(ies) is recommended, the user may select an input (e.g., the negative input) to generate a new, second set of recommended non-existent software entity(ies). In other words, the user may re-execute the opportunity analysis or at least modules 330-345 of the opportunity analysis. In an embodiment in which these modules utilize inference (e.g., by applying a machine-learning model), the second set of recommended non-existent software entity(ies) may differ from the first set. It should be understood that the user may continue to select the input to request new sets of recommendations until the user is satisfied with the recommendations. In this manner, a user may cycle through recommendations to explore and discover other potential non-existent software entities to be built. It should be understood that each regeneration may represent negative feedback received by module 360.

Module 365 may update one or more models, used by AI agent 150, based on positive and/or negative feedback. It should be understood that feedback may be received from a plurality of users for each of a plurality of opportunity analyses. This feedback may be used to generate a new training dataset (e.g., with anonymized data) that may be used to retrain (e.g., modify the weights) of the model(s) used by AI agent 150, such as the predictive model used for gap analysis by module 330, the clustering model used by module 340, the explanation model used by module 345, the generative language model used by module 350 and/or other modules of AI agent 150, and/or the like. Such continuous monitoring and feedback enables AI agent 150 to evolve and iteratively refine the recommendations over time, for continual improvement in recommendation quality.

### 4. Graphical User Interface

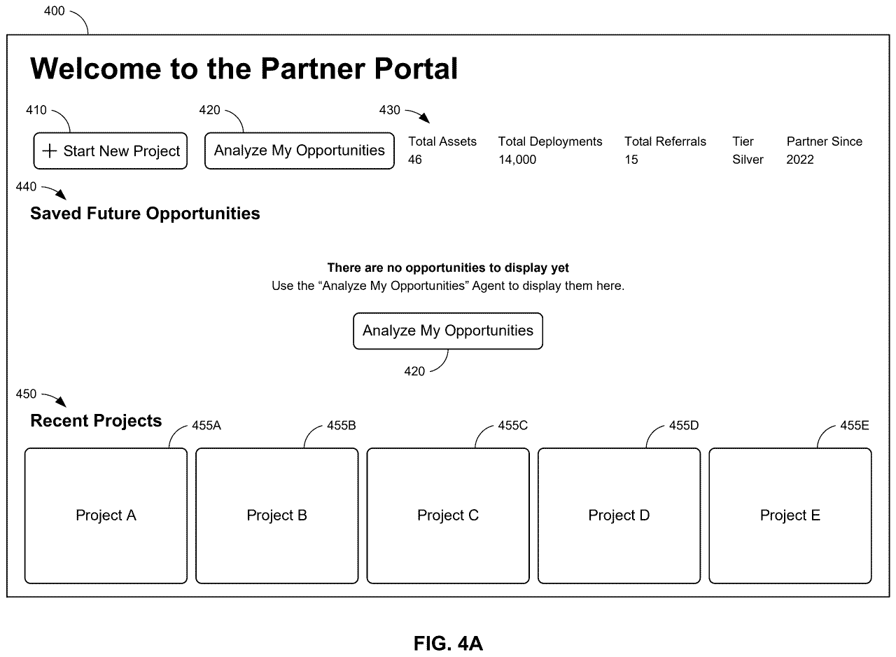

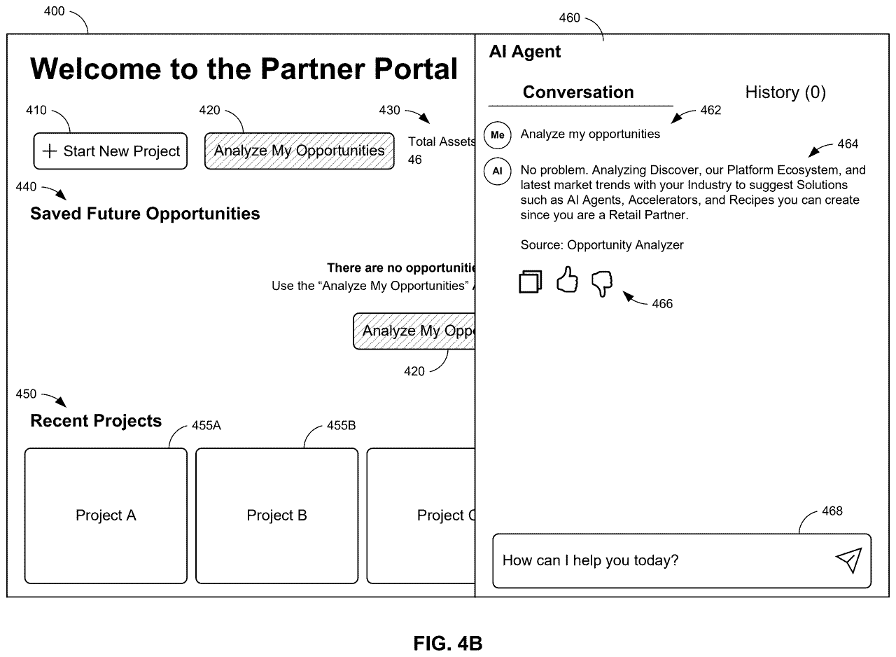

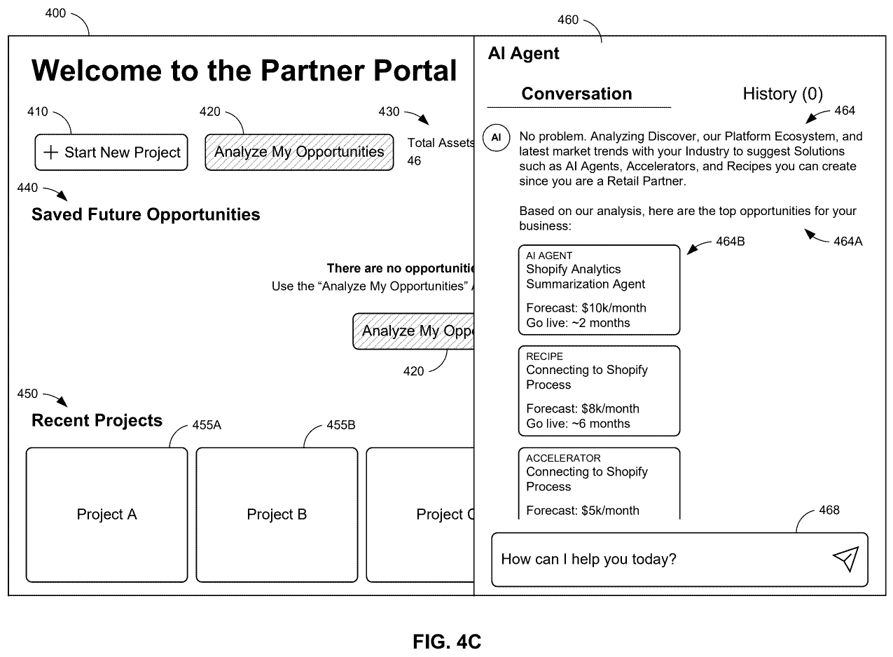

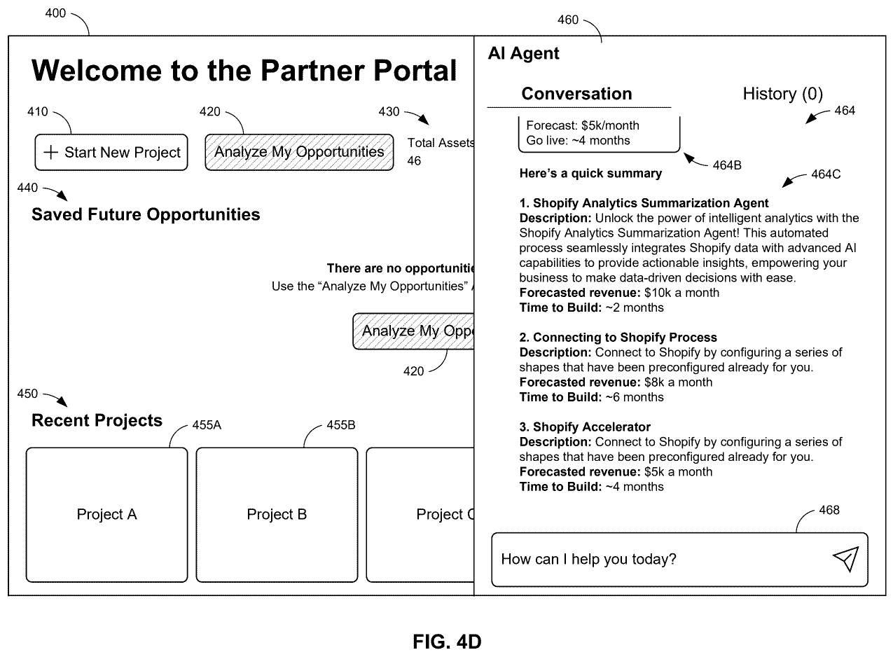

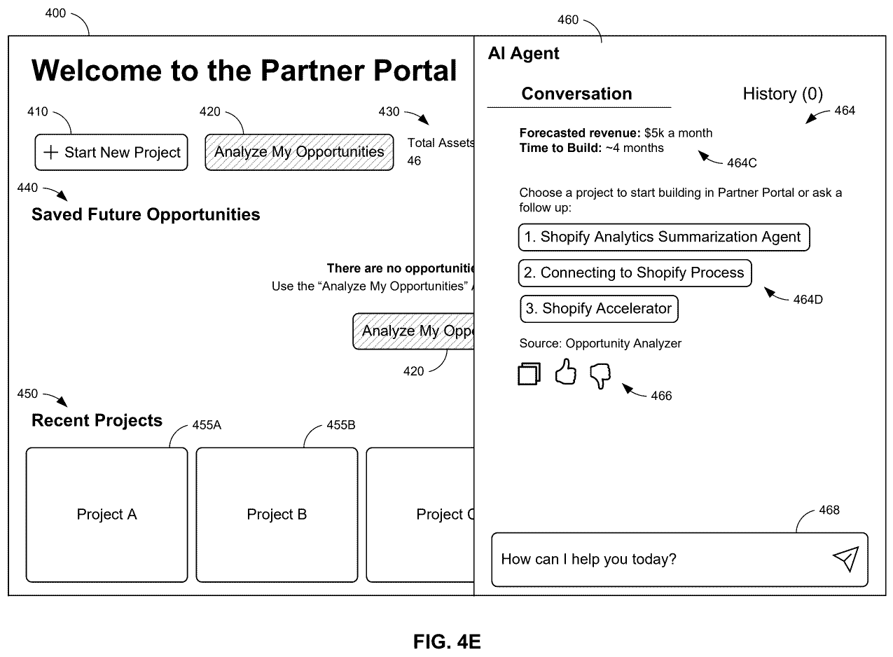

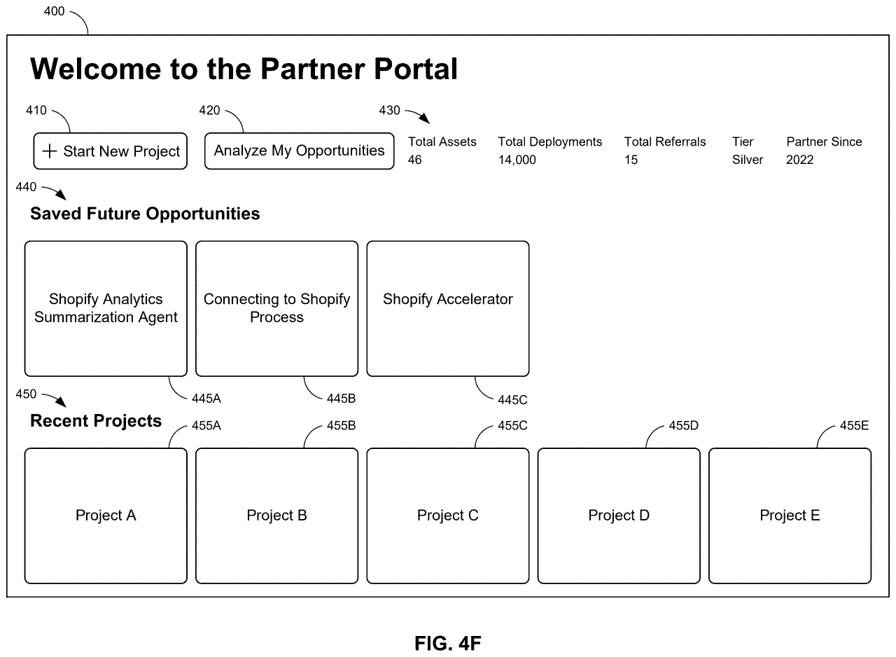

FIG. 4A illustrates an example dashboard in a partner portal of a graphical user interface 400 of user interface 115, according to an embodiment. Graphical user interface 400 may comprise an input 410 for starting a new project, one or more inputs 420 for initiating a new session of the opportunity analysis, statistics 430 for the partner, a region 440 that summarizes future projects that have not yet been started, a region 450 that summarizes recent projects, and/or the like. In response to the selection of input 410 by the user, graphical user interface 400 may be redirected to a screen for building a new software entity. Statistics 430 may comprise total published software entities, total deployments of those software entities, total referrals, a tier representing a status of the partner on platform 110, a date or duration since the partner joined the partner portal, and/or the like. Initially, before any opportunity analysis has been performed, region 440 may comprise an input 420 for initiating a new session of the opportunity analysis and prompt the user to use the opportunity analysis to help determine what project to start next. Region 450 may comprise visual representations 455 (e.g., tiles) representing projects that have been worked on recently, but remain uncompleted. For example, visual representations 455A, 455B, 455C, 455D, and 455E are illustrated as tiles. Each tile may be selectable and comprise a name of the software entity being built, a type of the software entity being built, a progress indicator (e.g., indicating a percentage of the project that has been completed), a description of the project, and/or the like. In response to the selection of one of visual representations 455, graphical user interface 400 may be redirected to a screen to continue building the software entity represented by the respective project. This screen may be the same as the screen for building a new software entity, to which graphical user interface 400 is redirected in response to the selection of input 410, but with the screen pre-populated with the current configuration of the software entity being constructed.

FIG. 4B illustrates the dashboard of graphical user interface 400, after the user has selected input 420, according to an embodiment. In response to the selection of input 420 by the user, a new real-time chat session is initiated (e.g., by module 305) with AI agent 150, and a chat frame 460 has been overlaid on the dashboard in graphical user interface 400. Chat frame 460 contains a record of the current real-time chat session, and may also provide access to a history of past chat sessions between the user and AI agent 150. In the illustrated embodiment, the chat session is seeded with an initial task-specific request 462 to AI agent 150, which is a conversational agent. This initiates an iteration of the opportunity analysis, represented by modules 310-355. As it may take more than a few seconds of computational time to run the opportunity analysis, AI agent 150 may provide an initial response 464, in natural language, to let the user know that AI agent 150 is in the process of performing the opportunity analysis. As discussed elsewhere herein, AI agent 150 may use a generative language model to generate response 464. Chat frame 460 may also include one or more inputs 466, associated with response 464, including an input for copying the response to the clipboard of user system 130, a positive input for providing positive feedback, a negative input for providing negative feedback, and/or the like. Chat frame 460 may also comprise a textbox input 468 in which the user may enter a new natural-language input within the real-time chat session.

In the illustrated example, the user is a partner that offers software entities for sale within the marketplace of platform 110. In response to the partner selecting input 420, chat frame 460 slides out from the right side of graphical user interface 400, and a new chat session is seeded with a request 462 to “Analyze my opportunities.” In response to request 462, AI agent 150 generates a natural-language expression (e.g., using a generative language model), which is output to chat frame 460 as response 464, and initiates an iteration of the opportunity analysis. Response 464 informs the user that AI agent 150 is analyzing the marketplace and computing environment 105 of platform 110, as well as market trends, to suggest solutions that can be built by the partner. In the background, AI agent 150 will perform the opportunity analysis by executing modules 310-355 to analyze internal and/or external data to identify gaps in the existing software entities that are currently available in computing environment 105, and recommend non-existent software entities that can be built by the partner to solve the identified gaps.

FIGS. 4C-4E illustrate chat frame 460, after AI agent 150 has completed the opportunity analysis and output the rest of response 464, according to an embodiment. Again, response 464 may be generated by a generative language model used by AI agent 150. Response 464 now includes initial response 464A, visual representation(s) 464B (e.g., tiles) of each recommended non-existent software entity, a summary 464C of each recommended non-existent software entity, and input(s) 464D for starting a new project to build each recommended non-existing software entity. Each visual representation 464B may comprise the type of software entity being recommended, a name or other descriptor of the software entity being recommended, a forecast of revenue (e.g., monthly revenue) to be generated by the software entity being recommended, a predicted time duration (e.g., in months) required to build the software entity being recommended, and/or the like. Summary 464C may comprise a list that includes each recommended non-existent software entity, along with the descriptor of the software entity being recommended, a natural-language description of the software entity being recommended (e.g., including an explanation of why the software entity is being recommended), a forecast of revenue to be generated by the software entity being recommended, a predicted time duration required to build the software entity being recommended, and/or the like. Each input 464D may comprise a selectable descriptor of the software entity being recommended. In response to the selection of an input 464D by the user, graphical user interface 400 may be redirected to the screen for starting a new project (e.g., the same screen to which graphical user interface 400 is redirected in response to the selection of input 410 and/or the selection of a visual representation 455), but with pre-populated data (e.g., field values, components, etc.). Thus, the user can immediately begin building the recommended software entity.

In the illustrated example, AI agent 150 performs the gap analysis in module 330, which analyzes user activity in computing environment 105 to reveal that customers in the retail sector who frequently utilize the Shopify™ connector generate significant spending. This indicates a strong demand for enhanced functionality with the Shopify™ application. Next, the clustering in module 340 may identify three non-existent software entities that are relevant to the partner and which would satisfy this demand for enhanced functionality: an AI agent for summarizing Shopify™ analytics; a template or “recipe” for an integration process that connects to the third-party Shopify™ application; and an accelerator for connecting to the third-party Shopify™ application. In this context, a recipe is a sample integration process that can be readily installed and configured to meet the user's specific needs, whereas an accelerator is a more complex blueprint for a solution that requires details from the user before being structured on a virtual canvas, and therefore, is not immediately installable, but is still a quicker implementation than starting from scratch. Accelerators are more architectural and conceptual than they are concretely defined, and may require a professional integration developer or implementation by a partner.

Notably, visual representations 464B include tiles representing the recommended non-existent software entities, with each tile including the name of the respective software entity, the forecasted revenue generated by the respective software entity, and an estimated time duration required to build the respective software entity. Similarly, summary 464C contains a list that represents each recommended non-existent software entity as an entry in the list, with each entry in the list including the name of the respective software entity, a brief description of the respective software entity, the forecasted revenue generated by the respective software entity, and an estimated time duration required to build the respective software entity. The brief description of each non-existent software entity (e.g., in summary 464C) may include the explanation of why the non-existent software entity is being recommended, as determined by module 345.

In addition, an input 464D is provided for each recommended non-existent software entity. In response to the selection of an input 464D by the user, graphical user interface 400 may be redirected to the screen for starting a new project, with at least some project data pre-populated and/or pre-built according to the respective software entity. For example, in response to the user selecting an input 464D associated with the AI agent for summarizing Shopify™ analytics, a new project may be pre-populated with a title (e.g., “Shopify Analytics Summarization Agent”) and other field values, and a data structure, representing the new AI agent, may be pre-built to include a suitable or standard generative language model, a connector to the Shopify™ application (e.g., via an application programming interface of the Shopify™ application, which may be hosted on a third-party system 140), one or more modules for querying the Shopify™ application to obtain relevant information to be summarized, a predefined template for generating suitable prompts that instruct the generative language model to summarize the relevant information, and/or the like. As another example, in response to the user selecting an input 464D associated with the recipe for an integration process that connects to the third-party Shopify™ application, a new project may be pre-populated with a title (e.g., “Connecting to Shopify Process”), and a data structure, representing the new recipe, may be pre-built to include a connector configured to communicate with the Shopify™ application (e.g., via an application programming interface of the Shopify™ application, which may be hosted on a third-party system 140). A similar example may be envisioned for the accelerator for connecting to the third-party Shopify™ application.

Thus, the partner has the ability to view a set of one or more recommended non-existent software entities, along with easily consumable information about each recommended non-existent software entity, and immediately create a new project to begin building each recommended non-existent software entity. The partner may select one of the recommended non-existent software entities, based on the information provided, such as the estimated revenue and/or estimated time duration. For instance, the partner could choose to invest in the most profitable solution. In this manner, AI agent 150 works as a thought partner or collaborator that aids the partner in the creative aspects of research and development. Reducing the creative process from months to minutes can accelerate the addition of in-demand solutions to the marketplace of platform 110 and to computing environment 105. It should be understood that, when the partner selects one of the recommended non-existent software entities to begin building, that software entity may be excluded from subsequent opportunity analyses performed by other partners (e.g., via module 340), so as to prevent duplicate efforts. AI agent 150 may also learn (e.g., via module 365) what types of software entities partners are more inclined to build, based on their selections, so as to weight those types of software entities higher in subsequent opportunity analyses.

Alternatively or additionally, the partner may continue the chat session within chat frame 460. For example, the partner could select one of inputs 466 (e.g., the negative input) to regenerate the opportunity analysis. The partner could also type a new input into textbox input 468 to continue the conversation with AI agent 150. For example, the partner could request additional recommendations, ask follow-up questions about the recommendations, request more information about one or more of the recommendations, and/or the like. Thus, the partner can leverage the chat experience to explore solutions and understand into which solutions they should invest their limited development time.

FIG. 4F illustrates the dashboard of graphical user interface 400, after the user has ended the chat session, according to an embodiment. Chat frame 460 has disappeared. Notably, region 440 now includes visual representation(s) 445 (e.g., tiles) for one or more of the recommended non-existent software entities (e.g., all of the recommended non-existent software entities or a subset of the recommended non-existent software entities that were selected or saved by the user). In the illustrated example, region 440 comprises visual representations 445A, 445B, and 445C. Thus, partners can see previously recommended solutions, in case they wish to revisit past ideas. It should be understood that, if the user had selected an input 464D for starting a new project, a visual representation 455 for that new project may appear in region 450, instead of or in addition to a visual representation 445 for that project appearing in region 440.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, by an artificial intelligence (AI) agent, during a real-time chat session between a user and the AI agent within a chat frame of a graphical user interface:
perform an opportunity analysis by
acquiring data comprising internal data from an integration platform as a service (iPaaS) platform, and external data that are external from the iPaaS platform, wherein the internal data comprise a plurality of datasets that each represents an existent software entity that already exists on the iPaaS platform,
applying a predictive model to the acquired data to predict a plurality of software entities that are likely to be used on the iPaaS platform,
clustering the predicted plurality of software entities into one or more clusters within a vector space, wherein each of the predicted plurality of software entities is represented as a feature vector within the vector space,
identifying at least one of the one or more clusters that is relevant to the user, and
identifying one or more non-existent software entities from the at least one cluster, wherein each of the one or more non-existent software entities does not already exist on the iPaaS platform; and
display a visual representation of each of the one or more non-existent software entities in the chat frame.

2. The method of claim 1, wherein the opportunity analysis is performed in response to an initial input within the chat frame.

3. The method of claim 2, wherein the initial input is predefined.

4. The method of claim 1, wherein the visual representation comprises a natural-language expression.

5. The method of claim 4, further comprising using the at least one hardware processor to generate the natural-language expression by:
generating a prompt based on the one or more non-existent software entities; and
inputting the prompt to a generative language model to produce the natural-language expression.

6. The method of claim 1, wherein the visual representation comprises, for each of the one or more non-existent software entities, an input for selecting the non-existent software entity, and wherein selection of the input for each of the one or more non-existent software entities redirects the graphical user interface to a screen for building the non-existent software entity, wherein the screen comprises pre-populated data for the non-existent software entity.

7. The method of claim 1, wherein the visual representation comprises, for each of the one or more non-existent software entities, an estimated revenue to be generated by the non-existent software entity.

8. The method of claim 1, wherein the visual representation comprises, for each of the one or more non-existent software entities, an estimated time duration to build the non-existent software entity.

9. The method of claim 1, wherein the opportunity analysis further comprises applying an explanation model to the feature vectors to generate an explanation for each of the one or more non-existent software entities.

10. The method of claim 9, wherein the visual representation comprises, for each of the one or more non-existent software entities, a natural-language expression of the explanation for that non-existent software entity.

11. The method of claim 1, wherein the opportunity analysis further comprises:
matching at least one of the predicted plurality of software entities to at least one of the existent software entities; and
based on the match, excluding the at least one predicted plurality of software entities from the one or more non-existent software entities.

12. The method of claim 1, wherein the opportunity analysis further comprises:
matching at least one of the predicted plurality of software entities to at least one software entity that is being built by another user; and
based on the match, excluding the at least one predicted plurality of software entities from the one or more non-existent software entities.

13. The method of claim 1, wherein at least one of the existent or non-existent software entities is an integration process.

14. The method of claim 1, wherein at least one of the existent or non-existent software entities is an AI agent.

15. The method of claim 1, wherein at least one of the existent or non-existent software entities is a connector to a third-party application.

16. The method of claim 1, wherein the internal data further comprise search queries within a marketplace of the iPaaS platform.

17. The method of claim 1, wherein the internal data further comprise usage statistics for the existent software entities.

18. The method of claim 1, wherein the external data comprise one or more online articles.

19. A system comprising:
at least one hardware processor; and
an artificial intelligence (AI) agent that is configured to, when executed by the at least one hardware processor, during a real-time chat session between a user and the AI agent within a chat frame of a graphical user interface,
perform an opportunity analysis by
acquiring data comprising internal data from an integration platform as a service (iPaaS) platform, and external data that are external from the iPaaS platform, wherein the internal data comprise a plurality of datasets that each represents an existent software entity that already exists on the iPaaS platform,
applying a predictive model to the acquired data to predict a plurality of software entities that are likely to be used on the iPaaS platform,
clustering the predicted plurality of software entities into one or more clusters within a vector space, wherein each of the predicted plurality of software entities is represented as a feature vector within the vector space,
identifying at least one of the one or more clusters that is relevant to the user, and
identifying one or more non-existent software entities from the at least one cluster, wherein each of the one or more non-existent software entities does not already exist on the iPaaS platform, and
display a visual representation of each of the one or more non-existent software entities in the chat frame.

20. A non-transitory computer-readable medium having instructions stored therein, wherein the instructions, when executed by a processor, cause the processor to, by an artificial intelligence (AI) agent, during a real-time chat session between a user and the AI agent within a chat frame of a graphical user interface:
perform an opportunity analysis by
acquiring data comprising internal data from an integration platform as a service (iPaaS) platform, and external data that are external from the iPaaS platform, wherein the internal data comprise a plurality of datasets that each represents an existent software entity that already exists on the iPaaS platform,
applying a predictive model to the acquired data to predict a plurality of software entities that are likely to be used on the iPaaS platform,
clustering the predicted plurality of software entities into one or more clusters within a vector space, wherein each of the predicted plurality of software entities is represented as a feature vector within the vector space,
identifying at least one of the one or more clusters that is relevant to the user, and
identifying one or more non-existent software entities from the at least one cluster, wherein each of the one or more non-existent software entities does not already exist on the iPaaS platform; and
display a visual representation of each of the one or more non-existent software entities in the chat frame.
